(19) United States
(12) Patent Application Publication
(10) Pub. No.: US 2012/0235792 A1
(43) Pub. Date: Sep. 20, 2012

(54) OUTER COVER OF A PORTABLE COMPUTER FOR RFID OBJECT MANAGEMENT SYSTEM

(75) Inventors: Pao-Chia HUANG, Hsinchu City (TW); Horng-Ji Chen, Hsinchu (TW)

(73) Assignee: ClarIDy Solutions, Inc., Hsinchu City (TW)

(21) Appl. No.: 13/281,840

(22) Filed: Oct. 26, 2011

(30) Foreign Application Priority Data
Mar. 18, 2011 (CN) 201110068144.7

(51) Int. Cl. G06K 7/01

(52) U.S. Cl. 340/10.1; 235/439

(57) ABSTRACT

An outer cover of a portable computer for RFID applications is disclosed, which comprises: a cover body formed of a nonmetallic material and provided for covering the portable computer; an RFID reader provided for detecting RFID tags on their corresponding objects; an antenna disposed in the cover body and provided for transmitting and receiving electromagnetic signals; a power interface provided for supplying power to the RFID reader; and a digital interface electrically connected to the portable computer and the RFID reader and provided for the transmission of data and control signals.

### TECHNICAL FIELD

The present invention relates to a radio-frequency identification (RFID) technique, and more particularly, to an outer cover of a portable computer for RFID applications and an RFID system for managing objects.

### TECHNICAL BACKGROUND

An RFID system mainly includes RFID tags, an RFID reader, and its application system. The RFID system can operates in low frequency (for example, 134 KHz), high frequency (for example, 13.56 MHz), ultra-high frequency (for example, 860 to 960 MHz), or microwave frequency (for example, 2.4 GHz). There is no battery included in a passive RFID tag, and its inside circuit is driven by the power transferred in electromagnetic waves from the RFID reader. The memory in the RFID tag can be classified into different types, such as read-only, write-once-read-many (WORM) and erasable programmable memories, according to their circuit design and fabrication process. The RFID tag can be tagged on a commodity object to record the information of the object's production, inventory, selling, and so on. An antenna is electrically connected to the RFID reader to transmit electromagnetic waves and control commands, and thereby receive the data information from the RFID tag for the further applications of individual object or personnel management.

In a conventional way, an RFID reader with an antenna are built-in in a mobile electronic device, using a cable to connect an external RFID reader and antenna, or a mobile electronic device is directly linked with RFID reader and using an RF cable to connect to an external antenna. In the first type, the RFID reader, antenna and the mobile electronic device need to be designed and developed concurrently. However, the product life cycle of the mobile electronic device is short due to the computing power and functionality progressing rapidly, the mobile electronic device and the RFID reader are subjected to different technical fields. In addition, there are different kinds of regulation certificates need to be certified, those need to have a longer development period. It's possible to finish the product development but had faced the phenomena of being phased out, and the overall cost is quite expensive in this manner. In another prior art, an individual RFID reader with an antenna can be externally connected to a mobile electronic device via a cable, or a mobile electronic device with an RFID reader can be connected to an external antenna via a cable. However, it is inconvenient to have the mobile electronic device with one hand while have the RFID reader or the antenna with the other hand during operation. Usually the operation is performed by multiple persons, which is not only inconvenient but also causes additional human resource cost. Especially, the mobile electronic device is supposed to be moved easily and quickly; once it needs to be operated by multiple persons, its mobility and efficiency would get great losing.

### TECHNICAL SUMMARY

To solve the foregoing problems, one of the major objectives of the present invention is to apply the RFID technology to develop an outer cover having an RFID reader and an antenna for a portable computer. The outer cover can be designed in an elegant foldable style. The RFID reader and the antenna are disposed in the outer cover, which can be folded and unfolded conveniently and used with the portable computer to do the mobile application services, such as merchandise searching, trading, storage and retrieval processes, tour guide of art collection, book reservation management, and logistics operations of manufacture, inventory and selling, etc.

Another objective of the present invention is to reduce the wastes of resources. The outer cover can further include elastic cords or Velcro cords, so as to fix and unfix the portable computer of various sizes therein conveniently, such as a tablet computer, a handheld computer, a laptop computer, or a personal digital assistant (PDA). A single outer cover can be used to pack or enclose one of the various portable computers, such that it's not only to minimize the wastes of resources, but also provides an optimized reusable solution to perform the variety of the mobile application services.

The RFID reader can be electrically connected to the portable computer via a cable to get the operating power, to achieve the purpose of carrying conveniently. If it needs to operate a longer period of time, an auxiliary battery, such as a lithium battery or a flexible battery, can be added to the outer cover to increase the power capacity and extends its working hours.

To accomplish the above purposes, one aspect of the present invention, an embodiment provides an outer cover of a portable computer for RFID applications, which comprising a cover body formed of a nonmetallic material and provided for covering the portable computer; an RFID reader provides for detecting RFID tags on their corresponding objects; an antenna is disposed in the cover body and provides for transmitting and receiving electromagnetic signals; a power interface provides for supplying power to the RFID reader; and a digital interface is electrically connected to the portable computer and the RFID reader and provides for transmitting and receiving data and control signals.

Another aspect of the present invention, an embodiment provides an RFID system for managing objects, the RFID system including an outer cover having an RFID reader and an antenna to cover with a portable computer and comprising multiple functional modules provided for performing the service of inquiring the objects, trading the articles, distributing the goods logistically, inventory managing of the objects, stocktaking for the goods, and promoting the articles, etc. As the commodity trade expands increasingly and the object management system thereof is getting more and more complex, it is necessary to have an efficient way providing wireless services of inquiring, trading, logistics distributing, inventory managing, and promoting of articles.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a perspective diagram of an outer cover for a portable computer according to an embodiment of the present invention schematically.

FIG. 2 is a perspective diagram of an outer cover for a portable computer according to another embodiment of the present invention.

FIG. 3 is a perspective diagram of an outer cover for a portable computer according to another embodiment of the present invention.

FIG. 4 is a perspective diagram of an outer cover according to the embodiments with its cover body fully folded.

FIG. 5 is a perspective diagram of an outer cover according to the embodiments with its cover part unfolded and stacked under the bottom part for the service operating.

FIG. 6 is a schematic diagram of an RFID system for managing objects according to another embodiment of the present invention.

### DESCRIPTION OF THE EXEMPLARY EMBODIMENTS

For further understanding and recognizing the fulfilled functions and structural characteristics of the disclosure, several exemplary embodiments cooperating with detailed description are presented as the following.

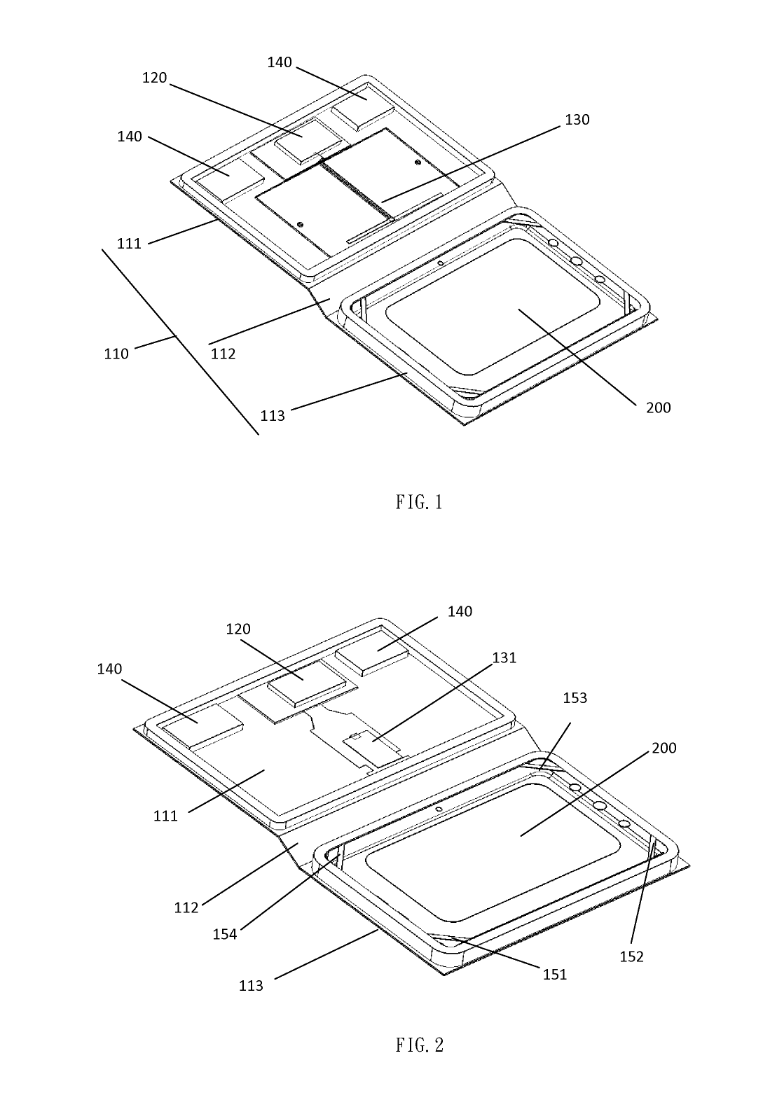

The present invention is mainly applicable to the technical field of radio-frequency identification (RFID). FIG. 1 shows a perspective diagram of an outer cover for a portable computer 200 according to an embodiment of the present invention schematically. The outer cover of the portable computer 200 includes a cover body 110, an RFID reader 120, an antenna 130, a power interface (not shown), and a digital interface (not shown). The cover body 110 comprises a cover part 111, a side part 112, and a bottom part 113. Each of the parts may be shaped like a plate basically, but is not limited thereby; it can be the other shapes. The cover part 111 can be folded to and unfolded from the cover body 110. For the sake of convenience of being understood, the outer cover illustrated in FIG. 1 is in the unfolded condition. The cover body 110 provides the functions for covering and packing the portable computer 200. Each part of the cover body 110 is composed of a nonmetallic material, for example, leather, plastics, wood, paper, textile, or the combination thereof, so that the portable computer 200 can be well protected and the electromagnetic signals of the RFID reader 120 can be transmitted and received without inappropriate influence. The portable computer 200 provides functions of computation and management, which can be a tablet computer, a handheld computer, a laptop computer, a personal digital assistant (PDA), or the like. An object information system can be included and installed in the portable computer 200, which is operable to inquire the objects, trade the articles, distribute the goods logistically, manage inventory of the objects, take stock for the goods, and promote the articles.

The RFID reader 120 detects the RFID tags which are disposed on their corresponding objects in the radio-frequency (RF) field. As shown in FIG. 1, the RFID reader 120 is disposed in the cover part 111 of the cover body 110. The RFID reader 120 provides the capability of the portable computer 200 to perform the radio-frequency identification and management of the objects. The antenna 130 is also disposed in the cover part 111 of the cover body 110 and is electrically connected to the RFID reader 120 for transmitting and receiving the electromagnetic signals, so as to read information in the RFID tags of the objects for the goods management. The antenna 130 is connected to the RFID reader 120 by an RF coaxial cable, but is not limited thereby. The antenna 130 may be selected from the group consisting of a dipole antenna, a patch antenna, a microstrip antenna, a panel antenna, and a planar inverted-F antenna (PIFA), but is not limited thereby. The digital interface is electrically connected between the portable computer 200 and the RFID reader 120. The digital interface serves as an interface between the portable computer 200 and the RFID reader 120 for the transmission of data and control signals. The digital interface may be selected from the group of Universal Serial Bus (USB), RS-232, RS-485, RS-422, Inter-Integrated Circuit (I²C), and Interface Segregation Principle (ISP), depends on the practical necessity. The power interface is provided for supplying power to the RFID reader 120, and it can be an USB interface or a power line connected to the portable computer 200 to get the power thereof. Also, the power interface can be a power line connected to a battery 140 or a plurality of batteries arranged in the outer cover, so as to increase the service hours of the RFID reader 120. Preferably, the battery 140 is of carrying convenience and large power capacity, such as a lithium battery and a flexible battery for a portable computer.

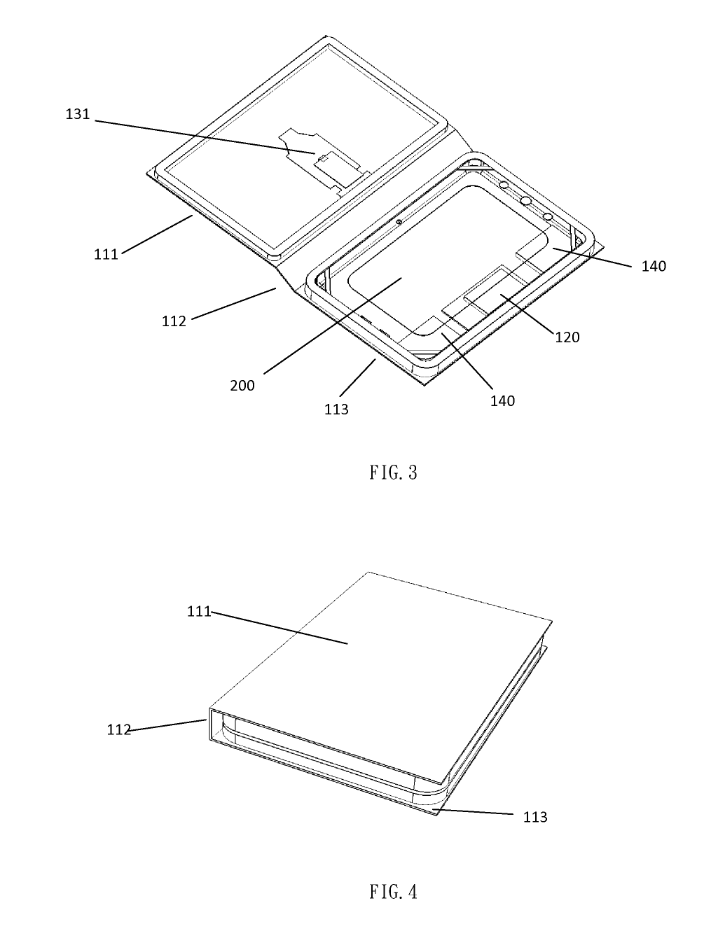

FIGS. 2 and 3 show perspective diagrams of outer covers for a portable computer 200 according to another two embodiments of the present invention, respectively. Basically, the structures of the outer covers in FIGS. 2 and 3 are identical to the one in FIG. 1, in which both the RFID reader 120 and the antenna 130 are disposed on the cover part 111 of the cover body, except that the antenna 131 is of different type. More than one RFID reader and antenna can be disposed in the outer cover, and the RFID reader(s) and the antenna(s) can also be disposed on the cover part 111 or the bottom part 113 of the cover body. It should be prevented that the electromagnetic radiation of the antenna 130/131 from shielding by any metallic material, so that the RFID reader 120 can transmit the electromagnetic signals smoothly to access the information in the RFID tags. Moreover, the cover body further includes elastic cords or Velcro cords 151 to 154 disposed at four corners of the bottom part 113 of the cover body, so that various sizes of the portable computer 200 can be fixed and unfixed in the cover body 110 conveniently.

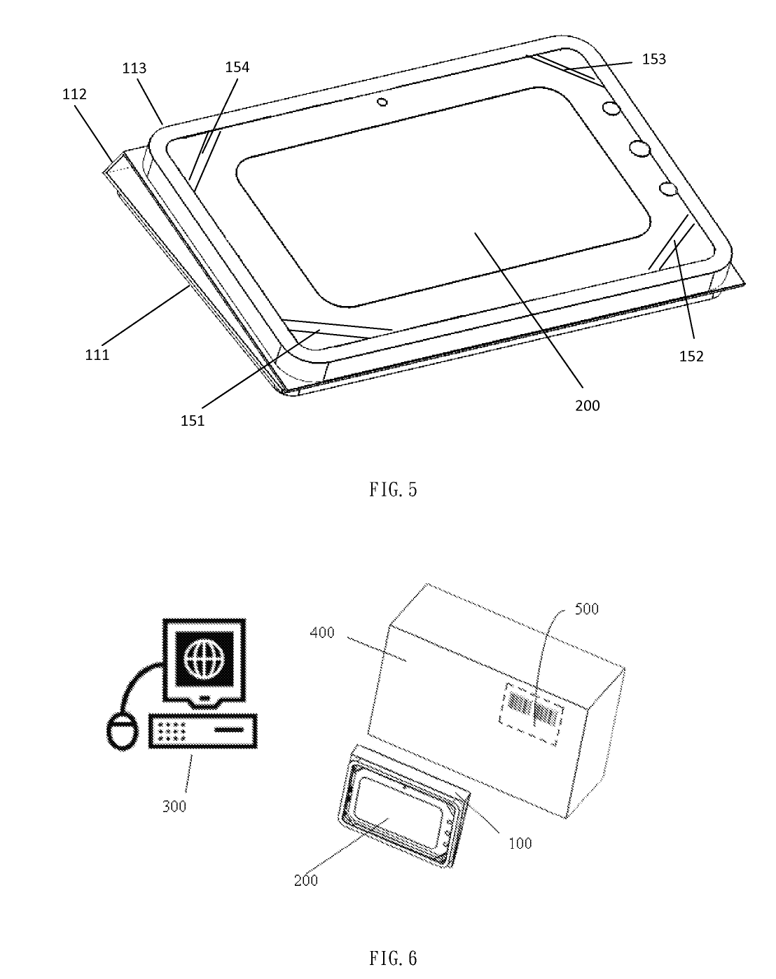

Each of the outer covers in FIGS. 1 to 3 is designed to have a foldable cover body 110, and they are illustrated unfolded in the diagrams, respectively. When the portable computer 200 is not being in use, the cover body is kept folded as shown in FIG. 4, and the cover part 111, the side part 112, and the bottom part 113 enclose or cover the portable computer inside the outer cover. Instead, when the portable computer 200 is being operated, the cover part 111 can be unfolded and stacked under the bottom part 113 as shown in FIG. 5. The cover body 110 can be designed in a shape of a book, a brand bag, or an elegant decoration, so as to improve appearance quality of and add RFID functions to the portable computer.

FIG. 6 shows a schematic diagram of an RFID system for managing objects according to another embodiment of the present invention. The RFID system includes a portable computer 200 and an outer cover 100, which can be the one in the foregoing embodiments. The portable computer 200 can communicate with a computer host 300 in a wireless way such as the wireless local area network (WLAN), the mobile phone communication, the Bluetooth communication, and the ZigBee communication, so as to perform various functions of wireless data communication, for example, internet connection, system control, file and database access, and web browser searching, etc. An RFID tag 500 can be disposed or tagged onto each of the objects 400, which may be a commodity, a product, a book, or an artwork. The RFID system according to the embodiment can be developed as an RFID object management system, which includes the above outer cover 100 and the portable computer 200 to perform the services of inquiring the objects, trading the articles, distributing the goods logistically, managing inventory of the objects, stocktaking for the goods, and promoting the articles. As the commodity trade expands increasingly and the object management system thereof is getting more and more complex, it is necessary to have an efficient way providing wireless services of inquiring, trading, logistics distributing, inventory managing, stocktaking, and promoting of articles.

As the commodity variety grows in types and items, it is a main trend to exploit the RFID technology in the field of product management. A software system of object management can be installed in a portable computer, which can be combined with the outer cover to perform the RFID functionality. Whereby, the software system can further include user management module for performing the service of managing user information of the operations. Preferably, the user management module is operable to read an RFID tag or a user account and the password controls, so that a user can enter the RFID management system to perform inquiring, trading, logistics distributing, inventory managing, stocktaking, and promoting of the individual entity of a commodity, a product, a book, a cultural collection or an artwork. The information of each object may includes its title, code or RFID tag number, style, color, size, material, price, and inventory quantity. A user can inquire and trade the objects through the RFID system with the object management software. Another functional module of the object management software is stocktaking which mainly includes listing of product items, inventory locations, storage quantity, and expiration date managements, so that the production, inventory and selling process management can accomplish the maximum benefits. Therefore, the RFID object management system includes the user operation controls to input a user account or read user's RFID tag with password verification to enhance the security level of the system operation.

Furthermore, the RFID object management system includes the RFID system control function to identify the objects or their corresponding users. Wherein, the system can search the information of each object may includes its title, code or RFID tag number, style, color, size, material, price, and inventory level, so that the RFID object management system can provide the service of inquiring and trading of the objects. The stocktaking module of the RFID object management system can be operable to list the stock information of at least one of the objects including their titles, inventory levels, quantities, and expiration dates. Where, the portable computer 200 can communicate with the internet or an external computer through a wireless network communication, so as to access a file or database, and to do the system manipulation.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An outer cover of a portable computer for RFID applications, the outer cover comprising:
a cover body formed of a nonmetallic material and provided for covering the portable computer;
an RFID reader provided for detecting RFID tags on their corresponding objects;
an antenna disposed in the cover body and provided for transmitting and receiving electromagnetic signals;
a power interface provided for supplying power to the RFID reader; and
a digital interface electrically connected to the portable computer and the RFID reader and provided for the transmission of data and control signals.

2. The outer cover of claim 1, wherein the portable computer is selected from the group consisting of a tablet computer, a handheld computer, and a PDA.

3. The outer cover of claim 1, wherein the portable computer comprises an object information system being operable to inquire the objects, trade the objects, distribute the objects logistically, manage inventory of the objects, take stock for the objects, and promote the objects.

4. The outer cover of claim 1, wherein the cover body is formed of leather, plastics, wood, paper, or textile.

5. The outer cover of claim 1, wherein the RFID reader is disposed in the cover body.

6. The outer cover of claim 1, wherein the antenna is electrically connected to the RFID reader.

7. The outer cover of claim 6, wherein the antenna is connected to the RFID reader by an RF coaxial cable.

8. The outer cover of claim 1, wherein the digital interface is selected from the group consisting of USB, RS-232, RS-485, RS-422, I²C, and ISP.

9. The outer cover of claim 1, wherein the power interface comprises a USB interface or is connected to the portable computer by a power line.

10. The outer cover of claim 1, wherein the power interface comprises a power line connected to a battery.

11. The outer cover of claim 10, wherein the battery comprises a lithium battery or a flexible battery.

12. The outer cover of claim 1, wherein the cover body includes an elastic cord or a Velcro provided for fixing the portable computer of various sizes.

13. An RFID object management system for managing objects, the RFID system including an outer cover having an RFID reader and an antenna to cover a portable computer and comprising:
a first functional module provided for performing the service of inquiring the objects;
a second functional module provided for performing the service of trading the objects;
a third functional module provided for performing the service of distributing the objects logistically;
a fourth functional module provided for performing the service of managing inventory of the objects;
a fifth functional module provided for performing the service of stocktaking for the objects; and
a sixth functional module provided for performing the service of promoting the objects.

14. The RFID object management system of claim 13, further comprising a seventh functional module provided for performing the service of managing user information.

15. The RFID object management system of claim 14, wherein the seventh functional module is operable to read an RFID tag number or an input of user account and to manage its password.

16. The RFID object management system of claim 13, further comprising an eighth functional module provided for performing the service of controlling the RFID reader, so as to identify the objects or the users.

17. The RFID object management system of claim 13, wherein the portable computer communicates with the internet or another computer via a wireless communication, so as to control the RFID object management system, to access a file or a database.

18. The RFID object management system of claim 13, wherein the first functional module is operable to inquire a title, a code, or an RFID tag number of one of the objects and to display the object information including its style, color, size, material, price, and inventory level.

19. The RFID object management system of claim 13, wherein the fifth functional module is operable to list the stock information of at least one of the objects including their titles, inventory levels, quantities, and expiration dates.
